(19) United States
(12) Patent Application Publication
(10) Pub. No.: US 2002/0035931 A1
(43) Pub. Date: Mar. 28, 2002

(54) System and process for continuously filtering shortening, oil and the like

(76) Inventors: William Tschopp, Lewisville, NC (US); Garcie Mccall, Germanton, NC (US); Richard B. Batte, Pfafftown, NC (US); Stan Lowry, Kernersville, NC (US)

Correspondence Address: J. Steven Gardner, Kilpatrick Stockton LLP, 1001 W. Fourth Street, Winston-Salem, NC, 27101, US

(21) Appl. No.: 09/949,446

(22) Filed: Sep. 7, 2001

Related U.S. Application Data
(60) Provisional application No. 60/230,817, filed on Sep. 7, 2000.

(51) Int. Cl. A47J 37/12

(52) U.S. Cl. 99/408; 99/403

(57) ABSTRACT

A system for filtering shortening in a food production process comprises a fryer having a bottom and a side wall, a shortening removal tap positioned on the side wall, a pump, and a filter. Shortening is removed from the fryer through the shortening removal tap. The shortening is then passed through the filter and returned to the fryer.

### CROSS-REFERENCE TO RELATED APPLICATIONS

This application claims priority to, and incorporates by reference in full, the following co-pending application of Applicant: U.S. Provisional Patent Application Ser. No. 60/230,817, filed Sep. 7, 2000, entitled “System and Process for Continuously Filtering Shortening, Oil and the Like.”

### FIELD OF THE INVENTION

The present invention relates generally to a system and process for filtering shortening, and, in particular, to a system and process for filtering shortening used in cooking applications.

### BACKGROUND

In the commercial food industry, food items, such as chicken, french fries, and doughnuts, are often cooked in oil or shortening. For example, doughnuts are typically cooked by continuously transporting raw dough through a fryer containing shortening at a high temperature. Typical shortening temperatures for cooking doughnuts range from 340 to 400° F. Fryers for cooking doughnuts are usually large stainless steel vats.

Over time, as the doughnuts are cooked, the shortening degrades for a number of reasons. These reasons include the high temperature at which doughnuts are cooked, exposure to light, exposure to air and items that enter the shortening as the doughnuts are cooked, such as water, lipids and phospholipids released from the dough.

Due to this degradation of shortening, fryers used in doughnut production must be periodically cleaned. When the shortening degrades, a gummy substance begins to build up on the bottom and sides of the fryer. If a fryer is not cleaned frequently, the gummy substance becomes more difficult to remove as it carbonizes to the bottom and sides of the fryer and requires more work to remove. Typically, fryers used commercially in the production of doughnuts are cleaned once a week in a process that takes three to four hours and, in some cases, longer.

In a conventional cleaning process, the shortening is drained from the fryer. The fryer is then scraped to remove any buildup (e.g., carbon) from the fryer walls and bottom resulting from the shortening breakdown. Next, the fryer is filled with water and a detergent is added. The water and detergent are brought to a boil in the fryer for approximately forty-five (45) minutes. While the water and detergent are boiling in the fryer, the areas of the fryer that are not submerged are cleaned using a brush, rinsed down (saturating any gum buildup with detergent), and scraped clean. The fryer is then drained and refilled with water for a rinse cycle. The water is drained and any parts that were removed (e.g., a conveyor) are returned to the fryer. Finally, the fryer is refilled with shortening and the production of doughnuts resumes.

In the past, there have been attempts at monitoring and controlling the quality of shortening. The breakdown of shortening is indicated by various features, such as a change in shortening color, visible smoke emanating from the shortening, and increased absorption levels in the doughnuts. The breakdown of shortening may also be indicated by results from testing the shortening. For example, an increase in the free fatty acid content in the shortening indicates the degradation of the shortening. The quality of shortening has been monitored in the past by measuring the free fatty acid content or total polar materials in the shortening. For example, the free fatty acid content and total polar materials in the shortening may be periodically measured to determine when to discard the shortening.

Test Kit Technologies developed a series of tests, known as “Quick Test,” to test shortening. Such a test includes a free fatty acid test, a wet test, and a total polar materials test. With these tests, a test tube containing a gel is filled with shortening and heated. A reading is taken by measuring absorbance in a spectrophotometer. One disadvantage of such a test is that each lot number of test tubes has a unique chart associated with it to use to analyze the absorbance measurements. For a company having many restaurants and manufacturing facilities, the fact that each lot number of test tubes has a specific chart associated with it makes it difficult to implement a standardized testing procedure within the company.

One method of controlling the breakdown of shortening comprises the addition of “fry powder” to the shortening. Fry powder is an adsorbent that has been promoted as collecting suspended particles in the shortening into larger lumps that can be filtered using a conventional filtering system, such as a strainer basket. Such fry powder is problematic in that it is messy, results in foaming and splattering in the fryer, and leaves a residue on the doughnuts.

Prior attempts at controlling the breakdown of shortening have been ineffective. While the quality of the shortening may be measured by testing the free fatty acid content or the total polar materials in shortening, the shortening still breaks down at the same rate. Thus, companies that utilize shortening in their fryers must still clean the fryers at the same frequency. The shortening may be discarded when there is a change in its appearance (e.g., color), when the quality of the final product is affected or when the free fatty acid content or total polar materials are too high.

The process of cleaning the fryer as described above takes between 3 and 6 hours to complete, and the fryer is typically cleaned once a week. While the fryer is being cleaned, the production of doughnuts or other items on that production line is stopped. With the time and labor required to clean the fryer and the resulting production down time, it would be desirable to increase the amount of time between fryer cleanings.

Filtering systems have been developed for filtering motor oil and other engine oils or lubricants used in larger manufacturing facilities. These filtering systems, however, are difficult to scale down for use in a food manufacturing process. These filtering systems are also fairly complex and are difficult to maintain and service. For example, some of these systems require filter pads that need to be changed every day.

Other conventional systems comprise batch operations that require some amount of production downtime. Therefore, it is desirable to provide a filtering system for shortening in a food production process that is continuous, reliable and easy to maintain and service.

### SUMMARY OF THE INVENTION

One system according to the present invention for filtering shortening in a food production process comprises a fryer having a bottom and a side wall, a shortening removal tap positioned on the at least one side wall, a pump, and a filter. The shortening is removed from the fryer through the shortening removal tap, passed through the filter and returned to the fryer. One process according to the present invention comprises removing shortening from the fryer, passing the removed shortening through a filter, and returning the removed shortening to the fryer.

Embodiments of the present invention may, for example, comprise a process for frying doughnuts. One such embodiment comprises advancing doughnuts to a fryer filled with shortening, continuously filtering the shortening, cooking the doughnuts in the fryer and removing the doughnuts from the fryer. The filter is continuously filtered by continuously removing the shortening from the fryer, passing the removed shortening through a filter, and returning the removed shortening to the fryer.

The present invention recognizes the problems caused by free fatty acids and total polar materials in shortening in a fried food production process. For example, in the production of doughnuts, as the free fatty acid content increases, the heat transfer from the shortening in the fryer to the doughnut also increases. This increased heat transfer quickly forms a crust on the doughnut and provides insulation, such that it takes longer to cook the interior of the doughnut. The increased heat transfer may also cause a change in color on the doughnut surface. By advantageously reducing the free fatty acid content, the present invention results in the production of higher quality doughnuts over longer periods of production time.

It is a feature and advantage of the present invention to reduce the frequency of testing for free fatty acid content and total polar materials by improving the quality of the shortening as it is used.

It is another feature and advantage of the present invention to provide a continuous filtering system for shortening in a food production process that is easy to service and maintain.

It is a further feature and advantage of the present invention to provide a continuous filtering system for shortening in a food production process that reduces the safety hazards in the handling and replacement of filters.

It is a still further feature and advantage of the present invention to provide a continuous filtering system for shortening in a food production process that minimizes the presence of visible smoke from the shortening.

Another feature and advantage of the present invention is that it has the potential to lower and control the amount of free fatty acids in shortening during use.

A further feature and advantage of the present invention is that it has the potential to extend the period of time during which free fatty acids build up in the shortening, which results in fryer needing to be cleaned.

It is a still further feature and advantage of the present invention to provide a continuous filtering system for shortening in a food production process that improves the clarity of the shortening during use.

It is another feature and advantage of the present invention to provide a continuous filtering system for shortening in a doughnut production process that results in doughnuts with more consistent properties during a production run.

It is a further feature and advantage of the present invention to provide a continuous filtering system for shortening that maintains the quality of shortening between fryer cleanings.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE FIGURES

FIG. 1 is a side elevational view of an embodiment of a system of the present invention for filtering shortening in a food production process;

FIG. 2 is a top elevational view of an embodiment of a system of the present invention for filtering shortening in a food production process;

FIG. 3 is a schematic of an embodiment of a system of the present invention for filtering shortening in a food production process;

FIG. 4 is a side elevational view of a filter spacer for use in a system of the present invention for filtering shortening in a food production process;

FIG. 5 is a top elevational view of a filter spacer in a filter housing for use in a system of the present invention for filtering shortening in a food production process; and

FIG. 6 is a schematic of another embodiment of a system of the present invention for filtering shortening in a food production process.

### DETAILED DESCRIPTION

A process and system are provided for filtering shortening in a food production process utilizing a fryer. The system and process of the present invention may be implemented in the production of doughnuts, fried chicken, french fries, and other processes where food is cooked in oil or shortening.

One embodiment of a system for filtering shortening in a food production process comprises a fryer having a bottom and a side wall, a shortening removal tap positioned on the at least one side wall, a pump, and a filter. The shortening is removed from the fryer through the shortening removal tap, passed through the filter, and returned to the fryer. In a further embodiment, the shortening is pumped through the filter. The shortening removal tap is preferably positioned on the side wall approximately two inches from the bottom of the fryer.

In a further embodiment, after leaving the fryer, the shortening preferably passes through a strainer basket. The strainer basket removes larger particles and crumbs from the shortening. The size of the holes in the strainer basket determine the size of the particles and crumbs that are removed. A valve is preferably located before the strainer basket to stop the flow of shortening into the strainer basket so that the strainer basket may be cleaned.

The shortening is then passed through the filter. In one embodiment of the present invention, the shortening is pumped through the filter. The pump, in a further embodiment, has a pressure monitor and a pressure relief valve. The pressure monitor measures the pressure of the shortening to determine when the filter has become saturated. When the shortening pressure reaches a certain level, the pressure relief valve opens and the shortening enters a bypass loop within the pump such that the shortening no longer passes through the filter.

In a further embodiment, the filter is located in a filter housing having a filter housing cap and a filter housing drainage tap. The filter housing cap can be removed from the filter housing to replace the filter. The filter housing drainage tap includes a valve which can be opened prior to replacing the filter in order to drain any shortening in the bottom of the filter housing or trapped on the outside of the filter. A valve is preferably located between the pump and the filter housing to stop the flow of shortening into the filter housing so the filter can be replaced.

A filter for use in the present invention can preferably operate at temperatures of about four hundred degrees Fahrenheit (400° F.) and can preferably remove particles of about five microns or larger. The filter preferably has gaskets on each of its ends to seal the ends of the filter to the filter housing and to prevent the shortening from bypassing the filter inside the filter housing. In a further embodiment, a filter spacer is utilized to center the filter within the filter housing and to provide a better seal.

From the filter housing, the shortening returns to the fryer. In a preferred embodiment, the shortening returns to the fryer through a return pipe running across the width of the fryer. The return pipe preferably has one quarter inch holes spaced every two to three inches (2-3 inches) of its length that the shortening passes through to enter the fryer. The return pipe is preferably sealed at its end.

For fryers that hold large volumes of shortening, a multiple filter system may be used. In one embodiment, a system for filtering shortening in a food production process comprises a fryer having a bottom and a side wall, a shortening removal tap positioned on the side wall, at least one pump, and at least two filter housings. Each of the filter housings contains a filter and includes a filter housing cap and filter housing drainage tap. One or more pumps may be used to pump the shortening through the filters.

In one embodiment, the shortening is pumped through the filter housings by a single pump. Multiple pumps may be used depending on the amount of shortening to be filtered. In an embodiment utilizing a single pump, the conduit (e.g., pipe) leaving the pump splits such that the shortening can pass through two filters in a parallel alignment. In other words, the volume of shortening is divided and each divided portion passes through a single filter. By filtering the shortening using this configuration, a large volume fryer may run for a longer period of time before a filter change is needed.

The present invention also relates to a process for filtering shortening in a food production process utilizing a fryer. A process of the present invention comprises removing shortening from the fryer, passing the removed shortening through a filter, and returning the removed shortening to the fryer. In a further embodiment, the removed shortening is passed through a strainer basket before being pumped through the filter.

An embodiment of the present invention comprises a process for frying doughnuts. In an embodiment, such a process comprises advancing doughnuts to a fryer filled with shortening, continuously filtering the shortening, cooking the doughnuts in the fryer and removing the doughnuts from the fryer. The filter is continuously filtered by continuously removing the shortening from the fryer, passing the removed shortening through a filter, and returning the removed shortening to the fryer. In further embodiments, the cooked doughnuts are glazed and/or iced.

In an embodiment of the present invention, a filtering system (e.g., filter size) is selected that can be used in a variety of fryer sizes. This embodiment is useful for companies having numerous restaurants or manufacturing facilities in that a standard filtering system is selected and the companies can issue standard operating procedures (e.g., when to change the filters) to its employees. For example, a filtering system for a doughnut manufacturing facility would preferably be able to filter shortening from both a two hundred seventy (270) dozen doughnuts per hour fryer and a six hundred (600) dozen doughnuts per hour fryer.

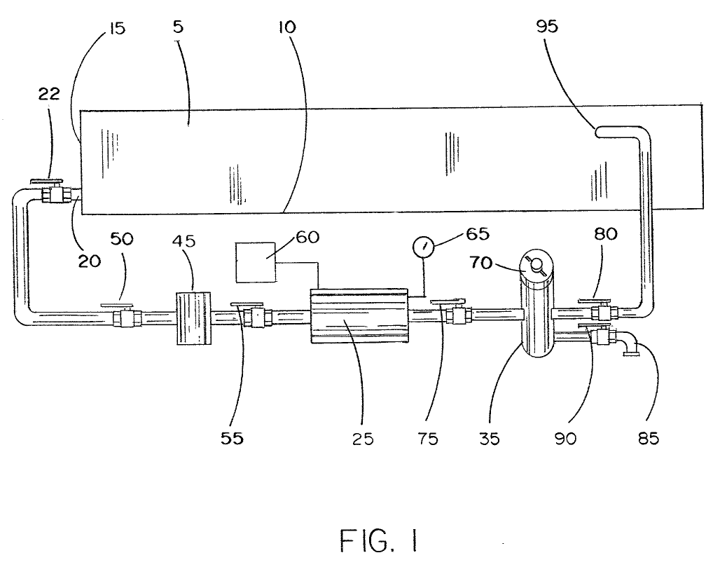

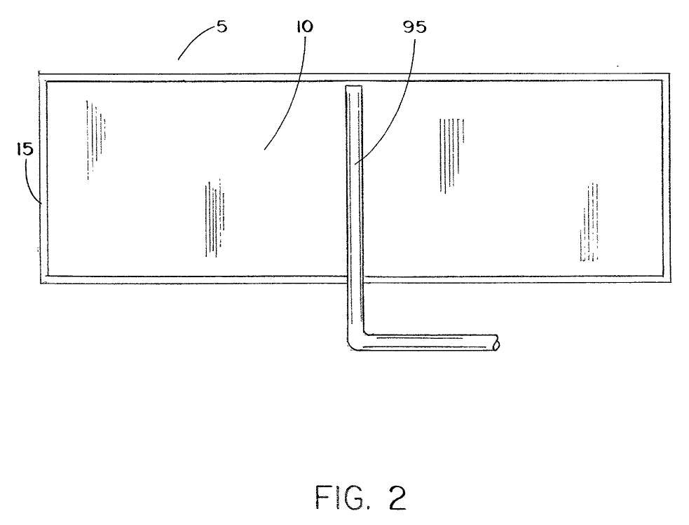

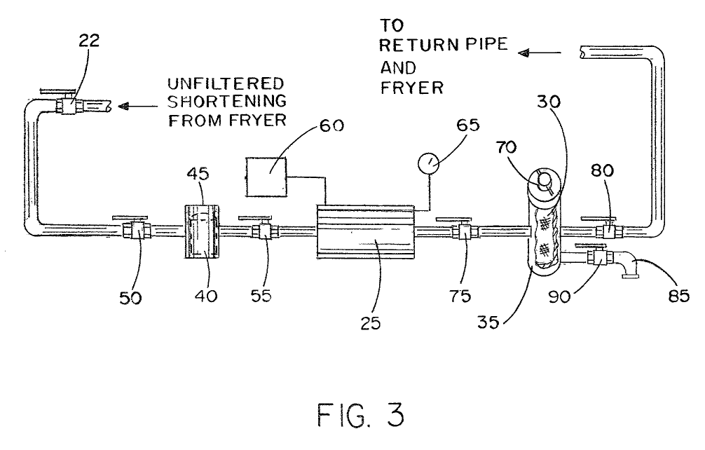

FIG. 1 is a side elevational view and FIG. 2 is a top elevational view of an embodiment of a system of the present invention for filtering shortening in a food production process. FIG. 3 is a schematic of an embodiment of a system of the present invention for filtering shortening in a food production process and illustrates the organization of some of the components shown and described in FIGS. 1 and 2.

The system for filtering shortening in a food production process utilizing a fryer 5 shown in FIGS. 1-3 comprises a fryer 5 having a bottom 10 and a side wall 15, a shortening removal tap 20 positioned on the side wall 15, a pump 25, and a filter 30. As shown in FIG. 1, the filter 30 is located inside of a filter housing 35. The shortening is removed from the fryer 5, pumped through the filter 30 and returned to the fryer 5.

The shortening is preferably removed from the fryer 5 through the shortening removal tap 20. The shortening removal tap 20 is preferably located on the side wall 15 approximately two inches from the bottom 10 of the fryer 5. The tap 20 is preferably placed in this position to remove the shortening and any particles suspended therein, while larger particles settle in the bottom of the fryer 5 and are removed when the fryer 5 is cleaned. A valve 22 near the shortening removal tap may be closed to prevent shortening from entering the filtering system.

In some instances, it may be desirable to remove the shortening through a tap or drain on the bottom of the fryer. When the tap or drain is located in the bottom of a fryer, the shortening is removed along with both suspended and settled particles. In an embodiment of the present invention for use in doughnut production, the side of the fryer is the preferred location because the present invention seeks to remove free fatty acids and other particles suspended in the shortening. The settled particles in shortening for doughnut production are typically larger particles, such as carbon particles, which are easier to remove than particles, such as free fatty acids, suspended in the shortening. These larger particles settle in the bottom of the fryer and are removed when the fryer is cleaned.

After leaving the fryer 5, the shortening passes through a strainer basket 40. The strainer basket 40 is located in a strainer basket housing 45. A strainer basket 40 may be a four inch tube with a diameter of one and one half inches comprised of holes having a diameter of one sixteenth of an inch. The strainer basket 40 strains the larger particles out of the shortening. Examples of strainer baskets useful in the present invention include Model No. 72, manufactured by Kraissl.

The system and process of the present invention can operate without a strainer basket, especially if the shortening is removed from the side of the fryer rather than the bottom. A preferred embodiment of the present invention includes a strainer basket because without a strainer basket, the filter has to be changed more often as larger particles would also be filtered.

When a strainer basket 40 is used, valves 50, 55 are preferably located on the pipes transporting the shortening to and from the strainer basket housing 45. By closing the valves 50,n 55 and preventing the flow of shortening through the strainer basket 40, the strainer basket 40 can be cleaned or changed.

After exiting the strainer basket 40, the shortening is preferably pumped through the filter 30 by a pump 25. Pumps useful in the present invention include Model No. EA0171011004 manufactured by Ingersoll Dresser. Any number of pumps might be used. An alternating current (AC) controller 60 is preferably connected to the pump 25 to control the flow rate of the shortening. When an eighteen inch (18″) filter is used with a two hundred seventy (270) dozen doughnuts per hour fryer, the shortening is preferably pumped at a rate between one (1) and six (6) gallons per minute. When two eighteen inch (18″) filters are aligned in parallel and used with a six hundred (600) dozen doughnuts per hour fryer, the shortening is preferably pumped at a rate between one (1) and six (6) gallons per minute.

The pump 25 preferably includes a pressure monitor 65, a pressure relief valve and a bypass loop. The pressure monitor 65 measures the pressure required to pump the shortening through the filter. As the filter becomes saturated, the pressure required to pump the shortening through the filter increases. Thus, one use of the pressure monitor 65 and pressure relief valve is to determine when the filter needs to be replaced.

When the shortening pressure reaches a particular level, the pressure relief valve opens and the shortening bypasses the filter and cycles within the pump. The pump 25 still operates in that the shortening leaving the outlet port cycles back through the inlet port of the pump 25 and no shortening passes through the filter 30. A person of ordinary skill in the art can readily determine the optimum pressure at which the relief valve should open. The pressure at which the relief valve opens is readily adjustable by tightening a screw on a spring or by substituting springs. In one embodiment, the pressure relief valve opens when the pressure reaches forty pounds per square inch (40 psi). However, as noted above, the pressure relief valve can be adjusted to open at other pressures. For example, the pressure relief valve may need to be adjusted if the pump speed is changed.

The shortening is pumped through a filter 30 located in a filter housing 35. The filter housing 35 includes a removable filter housing cap 70, which allows for the replacement of filters. When the system of the present invention is positioned beneath the fryer 5, the filter housing 35 is preferably diagonally oriented with regard to the ground for better accessibility to the filter 30. Because the filter 30 must be periodically changed, it is preferable to orient the filter housing 35 such that it is easy for an operator to remove the filter housing cap 70 and to replace the filter 30 in the filter housing 35. The filter housing is preferably a cylinder that is eighteen to twenty-four (18-24) inches long. Other sizes and shapes may be used, depending primarily on the size and shape of the filter used.

Valves 75, 80 are preferably located on both sides of the filter housing 35 in order to stop the flow of shortening through the filter housing 35 when the filter 30 needs to be changed. The flow of shortening can be completely shut off, so an operator can remove the filter housing cap, remove the old filter, and insert a new filter. Using this embodiment, the filter can be replaced without interrupting the production of doughnuts. It is preferable to let the filter housing and filter cool for about an hour before replacing the filter due to the shortening's high temperature, although the filter may be changed immediately if the appropriate protective equipment (e.g., gloves) is used.

The filter housing 35 preferably includes a drainage tap 85 to drain any shortening that may have settled in the bottom or that may have become trapped around the outside of the filter 30 (i.e., not pumped out of the filter housing 35 and back to the fryer 5). After the valve 75 prior to the filter housing 35 is closed and before replacing the filter, the excess shortening should be drained from the filter housing 35 through the drainage tap 85 by opening a valve 90 to the drainage tap 85. By draining the excess shortening, the step of replacing the filter becomes safer because there is less residual hot shortening on the filter.

A filter housing cap for the present invention may be a flat heavy steel filter cap.

Gaskets are preferably located on each end of the filter in order to seal the filter within the filter housing. The gasket must be able to withstand high temperatures without deforming or melting to the filter or filter housing. A preferable gasket for use in the present invention is constructed from Vicon rubber. It is important for the filter to be centered within the filter housing and for the gaskets on the ends of the filter to properly seal the ends of the filter housing. The gaskets on the ends of the filter are preferably flush with the ends of the filter housing and the filter housing cap to avoid creating a bypass within the filter housing such that the shortening could bypass the filter.

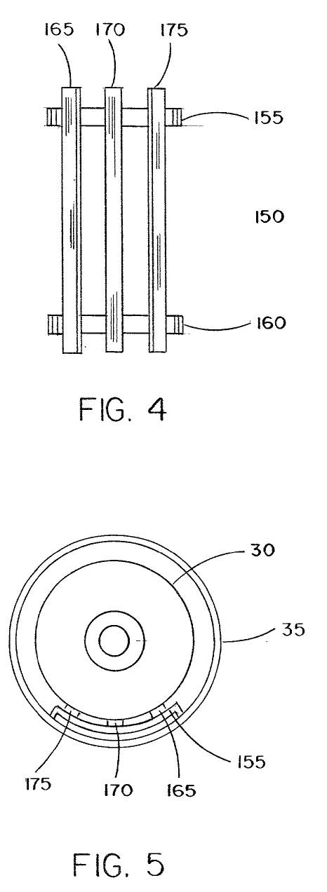

In one embodiment of the present invention, a filter spacer 150 is placed in the filter housing 35 to center the filter 30 in the filter housing 35. FIG. 4 is a side elevational view of a filter spacer 150. As shown in FIG. 5, the filter spacer 150 includes two arcuate members 155, 160 connected by three rods 165, 170, 175. The rods 165, 170, 175 are preferably just shorter than the length of the filter housing 35. For example, if the filter housing 35 has an interior length of eighteen inches, the rods 165, 170, 175 are preferably seventeen and one-half inches long. The filter spacer 150 is preferably constructed from steel.

FIG. 5 is a top elevational view of a filter spacer 150 positioned in a filter housing 35. FIG. 5 illustrates how the filter spacer 150 centers a filter 30 in the filter housing 35. The arcuate members 155, 160 space the rods 165, 170, 175 from the interior wall of the filter housing 35. The distance between the rods 165, 170, 175 and the interior wall of the filter housing is preferably three-quarters of an inch. The filter 30 rests on the rods 165, 170, 175 and is centered in the filter housing 35.

Filter spacers are preferably utilized in embodiments of the present invention where the filter housing is diagonally or horizontally oriented with respect to the ground. When the filter housing is vertically oriented with respect to the ground, filter spacers may not be necessary.

A filter for use in the present invention preferably has several characteristics. First, the filter must be able to withstand high temperatures, preferably temperatures of four hundred degrees Fahrenheit (400° F.) or higher. The filter should be able to remove particles (e.g., free fatty acids and polar materials) that are thirty microns (30 microns or 0.03 millimeters) or larger. The filter may be a ten micron (10 micron) filter to remove particles ten microns (10 microns) or larger in size. Smaller filters (e.g., two microns, five microns, etc.) may also be used. However, as the filter paper size decreases, the filter becomes more quickly saturated than with larger filter paper sizes, so that the smaller filters have to be replaced more frequently than larger filters. It would be preferable to utilize a filter that may be easily inserted and removed from a filter housing.

An example of a filter suitable for use in the present invention is Filter No. KK518-00-C, which is commercially available from The Hilliard Corporation, located in Elmira, N.Y. This filter utilizes a fluted (or pleated) design and filters particles that are approximately ten microns (10 microns) or larger.

Another example of a filter suitable for use in the present invention is Filter No. DX718-05-03ZX01, which is commercially available from The Hilliard Corporation, located in Elmira, N.Y. This filter utilizes a paper disc cartridge design with alternating solid discs and spoke discs.

After being filtered, the shortening returns to the fryer 5. In a preferred embodiment, the shortening returns to the fryer 5 through a return pipe 95 running across the width of the fryer 5. The return pipe 95 preferably has one quarter inch holes spaced every 2-3 inches of its length that the shortening passes through to enter the fryer 5. The return pipe 95 is preferably sealed at its end.

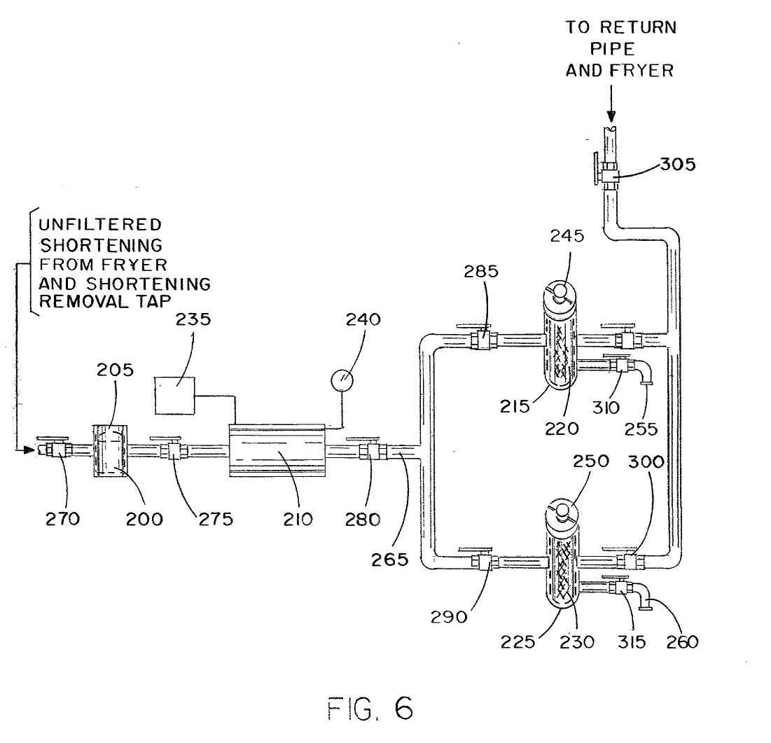

In food production process utilizing a large fryer, a multiple filter system may be used. FIG. 6 is a schematic of an embodiment of a system of the present invention for filtering shortening in a food production process utilizing a large fryer. The embodiment shown in FIG. 6 may be used, for, example, with a six hundred (600) dozen doughnuts per hour fryer. In the embodiment shown, two filters 220, 230 and one pump 210 are used to filter the shortening. In this embodiment, shortening is removed from a fryer by a shortening removal tap. The shortening passes through a strainer basket 200 in a strainer basket housing 205. A pump 210 transports the shortening to the two filter housings 215, 225. The pump 210 is controlled by an AC controller 235. The pump 210 also includes a pressure monitor 240, showing the pressure.

As shown in FIG. 6, the conduit 265 (e.g., pipe) leaving the pump 210 splits such that the shortening can pass through the two filter housings 215, 225, which are arranged in a parallel alignment. In other words, the volume of shortening is divided and each divided portion passes through a single filter. By filtering the shortening using this configuration, a large volume fryer may run for a longer period of time before a filter change is needed.

Each of the filter housings 215, 225 contains a filter 220, 230. The filter housing 215, 225 shown in FIG. 6 are diagonally oriented and also may include filter spacers. Each filter housing 215, 225 may also have filter caps 245, 250 and filter housing drainage taps 255, 260. After being filtered, the shortening is returned to the fryer through a return pipe across the width of the fryer having holes along its length. As seen in FIG. 6, numerous valves 270, 275, 280, 285, 290, 295, 300, 305, 310, 315 may be positioned within the system to stop the flow of shortening at various locations.

Filtering systems of the present invention may advantageously and easily be installed on existing fryers. To retrofit an existing fryer, a shortening removal tap should be installed on the fryer. The piping and other equipment (e.g., strainer basket, pump, filter(s), valves, etc.) are mounted on or around the fryer. A return pipe, such as the return pipe described above, is installed across the top of the fryer to return the shortening to the fryer.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

That which is claimed:

1. A system for filtering shortening in a food production process, comprising:
a fryer having a bottom and a side wall;
a shortening removal tap positioned on the side wall;
a pump; and
a filter;
wherein the shortening is removed from the fryer through the shortening removal tap, passed through the filter and returned to the fryer.

2. The system of claim 1, wherein the shortening is pumped through the filter.

3. The system of claim 1, wherein the shortening removal tap is positioned on the side wall approximately two inches from the bottom of the fryer.

4. The system of claim 1, wherein the pump includes a pressure relief valve.

5. The system of claim 4, wherein the pressure relief valve allows the shortening to enter a bypass loop within the pump when the shortening reaches a predetermined pressure.

6. The system of claim 1, further comprising a filter housing.

7. The system of claim 6, wherein the filter is located inside the filter housing.

8. The system of claim 6, wherein the filter housing comprises a filter housing cap.

9. The system of claim 8, wherein the filter housing further comprises a filter housing drainage tap.

10. The system of claim 1, further comprising a strainer basket.

11. The system of claim 10, wherein the strainer basket is located before the filter.

12. The system of claim 11, further comprising a valve located between the strainer basket and the filter.

13. The system of claim 10, further comprising a valve located before the strainer basket.

14. The system of claim 1, wherein the filter can operate at temperatures greater than 300 degrees Fahrenheit.

15. The system of claim 1, wherein the filter can operate at temperatures of greater than 350 degrees Fahrenheit.

16. The system of claim 1, wherein the filter can operate at temperatures of greater than 400 degrees Fahrenheit.

17. The system of claim 1, wherein the filter can remove particles of about 15 microns or larger.

18. The system of claim 1, wherein the filter can remove particles of about 10 microns or larger.

19. The system of claim 1, wherein the filter can remove particles of about 5 microns or larger.

20. A system for filtering shortening in a food production process, comprising:
a fryer having a bottom and a side wall;
a shortening removal tap positioned on the side wall;
at least one pump; and
at least two filter housings;
wherein the shortening is removed from the fryer through the shortening removal tap, passed through the filters and returned to the fryer.

21. The system of claim 20, wherein the shortening is pumped through the filter.

22. The system of claim 20, wherein the shortening removal tap is positioned on the side wall approximately two inches from the bottom of the fryer.

23. The system of claim 20, wherein the at least one pump includes a pressure relief valve.

24. The system of claim 23, wherein the pressure relief valve allows the shortening to enter a bypass loop within the at least one pump when the shortening reaches a predetermined pressure.

25. The system of claim 20, wherein each of the at least two filter housings contains a filter.

26. The system of claim 25, wherein each of the at least two filter housings comprises a filter housing cap.

27. The system of claim 26, wherein each of the at least two filter housings further comprises a filter housing drainage tap.

28. The system of claim 25, wherein the filter can operate at temperatures greater than 300 degrees Fahrenheit.

29. The system of claim 25, wherein the filter can operate at temperatures of greater than 350 degrees Fahrenheit.

30. The system of claim 25, wherein the filter can operate at temperatures of greater than 400 degrees Fahrenheit.

31. The system of claim 25, wherein the filter can remove particles of about 15 microns or larger.

32. The system of claim 25, wherein the filter can remove particles of about 10 microns or larger.

33. The system of claim 25, wherein the filter can remove particles of about 5 microns or larger.

34. The system of claim 19, further comprising a strainer basket.

35. The system of claim 34, wherein the strainer basket is located before the at least two filter housings.

36. The system of claim 35, further comprising a valve located between the strainer basket and the at least two filter housings.

37. The system of claim 34, further comprising a valve located before the strainer basket.

38. A process for filtering shortening in a food production process, comprising:
removing shortening from a fryer;
passing the removed shortening through a filter; and
returning the removed shortening to the fryer.

39. The process of claim 38, wherein passing the removed shortening through a filter comprises pumping the removed shortening through a filter.

40. The process of claim 38, further comprising passing the removed shortening through a strainer basket.

41. The process of claim 40, wherein the removed shortening is passed through the strainer basket before being pumped through the filter.

42. A process for frying doughnuts, comprising:
advancing doughnuts to a fryer filled with shortening;
continuously filtering the shortening;
cooking the doughnuts in the fryer; and
removing the doughnuts from the fryer.

43. The process of claim 42, wherein continuously filtering the shortening comprises continuously removing the shortening from the fryer, pumping the removed shortening through a filter, and returning the removed shortening to the fryer.

44. The process of claim 43, further comprising glazing the cooked doughnuts.

45. The process of claim 43, further comprising icing the cooked doughnuts.
